(19) United States
(12) Patent Application Publication
(10) Pub. No.: US 2003/0218597 A1
(43) Pub. Date: Nov. 27, 2003

(54) System and architecture for a wireless interactive presentation system

(76) Inventors: Migdat Hodzic, Cupertino, CA (US); George R. Lewis, Sunnyvale, CA (US); Glenn Perkins, San Jose, CA (US)

Correspondence Address: Ian L. Cartier, Patent Attorney, P.O. Box 3025, Fremont, CA, 94539, US

(21) Appl. No.: 10/154,083

(22) Filed: May 22, 2002

(51) Int. Cl. G09G 5/08

(52) U.S. Cl. 345/158

(57) ABSTRACT

Disclosed herein is a wireless interactive presentation system that operate in cooperation with a host computer system executing PC compatible application programs capable of generating and displaying text, image and graphic content on a projector or presentation device. The wireless interactive presentation system also includes a wireless data transceiver capable of communicating and exchanging application or system commands and data with a network-based computer system. The wireless interactive presentation system comprises a micro-controller, an infrared receiver and a wireless transceiver to provide short-range communication between the remote system and wireless interactive presentation system. The microcontroller of the wireless interactive presentation system executes a control program to process the commands and data received from remote computer via the wireless transceiver and provides the resultant application window, template, or graphical display data to projector or presentation device.

### BACKGROUND OF THE INVENTION

1. Field of the Invention

The present invention is related to presentation systems. More particularly, this invention relates to a wireless interactive presentation system that permits both interactive access and immediate use of an array of user-specified and created presentation and graphic content from a remote computer system via a high speed wireless communications network.

2. Description of the Related Art

In most business environments are changing at Internet speeds, where critical information change not just overnight, but over lunch, the need for a flexible, effective presentation system and architecture has become paramount. Not surprisingly, therefore, projectors and other presentation devices, when paired with a notebook computer and presentation application packages are increasingly becoming essential tools for the business professional. As a result, the field for computer-aided presentation system has grown dramatically in recent years. The acceptance and use of presentation applications such as Microsoft's “PowerPoint” and Aldus' “Persuasion” demonstrates the need to create professional looking presentations. With these applications a user or speaker can create presentations containing text, graphics and images in an effective and timely manner. Although these applications programs allow images, video and even sound to be incorporated into a presentation, they do not assist user or speaker to organize, manage and the presentation so it can easily be presented to an audience.

Charts, text, and various graphical images are typically presented to an audience in meetings and classrooms by projecting these images onto a screen or a wall. Liquid crystal display (LCD) projectors are typically used as a source, where the charts, text, or graphics are generated by a computer system, such as a personal computer (PC) or a notebook computer system executing an application such as Microsoft PowerPoint™. These LCD/PC projection systems have become more popular than the traditional overhead projector and transparencies that they replace. Whether the speaker is standing at a lectern, or is moving about before the audience, he has very little control over the image being displayed on the screen or wall when using such a LCD/PC projection system. These conventional systems require the speaker to constantly return to the computer, or to have an assistant seated at the computer to control the presentation. For example, in complex presentation environments, such as in a courtroom, hundreds of charts, images and displays of text content may be required over the course of a trial and are best operated by an assistant. The assistant adds the enhancements to the images, creates the scripts, and runs the scripts that manipulate the images and text content during the presentation.

The drawback of this approach is the cost and the time of creating a presentation as well as the problem of mislabeled, poorly organized presentation scripts that cause unwanted delays in the presentation. Additionally, it does not allow the user or speaker to be easily change, modify or correct the content of the material during the course of the presentation, as well. Also, the speaker's actions of moving back and forth from the presentation system or to communicate with his assistant, detracts dramatically from the natural flow of the presentation. In fact, according to a number of studies, the more a speaker is able to interactively control his presentation or is able to modify how the presentation appears on the screen without repeatedly diverting his attention from the audience to an assistant or a computer-based presentation system, the more easily the speaker develops a rapport with his audience.

The presentation system disclosed in U.S. Pat. Nos. 5,782,548, 5,502,459 and 5,682,181, issued to Nguyen et al., Marshall et al. and Miyashita, respectively, provide the speaker with a hand-held controller, like a laser pointer or a series of presentation menus in the form of pull down menus to manage a presentation system. Although the speaker acquires some mobility by means of these control functions, the mobility is limited as speaker must stay within close range of the presentation system or projector. Here, the speaker must turn away from his audience and direct his attention to the presentation system when he wishes to advance the presentation to next slide or image. In addition, such systems typically require multiple steps or actions be taken to control a typical presentation, which in turn, inhibits the natural progression and flow of presentation. Moreover, these systems do not allow the user or speaker to easily modify the graphics and text content, as needed, or alter the order of the images or slides during the course of a presentation.

There are several addition requirements that have not addressed by any of these systems. The first is the requirement of the speaker to be able to generate presentations quickly and easily. Additionally, there is a need to have the flexibility of changing the order or accessing many different informational or content segments in presentations without disturbing the communications process by blanking the audience display. Another important requirement is the demand for a number of connectivity options, both in terms of computer-oriented as well as network connections. Incorporating network connectivity into a presentation system adds a great deal of functionality, including the ability to “broadcast” presentations via a network facility to various audiences in different locations throughout a corporate facility or campus, and remotely manage the system via the network.

### SUMMARY OF THE INVENTION

A preferred embodiment of the present invention provides for the system and architecture of a wireless interactive presentation system. It is therefore an object of the present invention to provide such a presentation system which overcomes these and other limitations of conventional display presentation systems.

In accordance with the purpose of the invention, as embodied and broadly described herein, the invention relates to the use of a interactive presentation system that operates in collaboration with a network-oriented, remote host computer system executing an array of PC compatible application programs to create and display a variety of images, graphics and data content functions in response to a speaker's specified input. The host system also includes a wireless data transceiver capable of communicating and exchanging application or system commands and data between the host computer and wireless interactive presentation system. The wireless interactive presentation system comprises a microcontroller, a video controller that interfaces with the projector and a wireless transceiver to provide short-range communication to the host computer system. The microcontroller of the wireless interactive presentation system executes a control program to process the commands and data received from a remote computer system via the wireless transceiver to supply either presentation templates or slides or image data to a projector for display on a screen.

In further accordance with the purpose of the invention, as embodied and broadly described herein, is that the wireless interactive presentation system provides a cost effective, presentation facility with the flexibility to interact with a variety of graphic and presentation applications on a remote system to change the order and access different information or content segments in presentations without disturbing the communications process and, while retaining a high degree of interaction with the audience.

Another advantage of the present invention is that multiple personal mobile displays can be utilized in conjunction with a single network-based computer system to collaboratively provide access to applications executing on that computer system.

Advantages of the invention will be set forth, in part, in the description that follows and, in part, will be understood by those skilled in the art from the description herein. The advantages of the invention will be realized and attained by means of the elements and combinations particularly pointed out in the appended claims and equivalents.

### BRIEF DESCRIPTION OF THE DRAWINGS

For a further understanding of the objects and advantages of the present invention, reference should be had to the following detailed description, taken in conjunction with the accompanying drawing, in which like parts are given like reference numerals and wherein:

FIG. 1 is diagram illustrating a preferred embodiment of the invention shown in a typical corporate-wide client/server-networking environment.

FIG. 2 is a block diagram depicting the wireless interactive presentation system as implemented in accordance with the present invention.

FIG. 3 is a diagram showing a cut away view exposing the essential operative elements of the wireless interactive presentation system in accordance with the present invention.

FIG. 4 is a block diagram detailing the operative components found on the on-board processing system of the wireless interactive presentation system in accordance with the present invention.

### DETAILED DESCRIPTION OF THE INVENTION

The present invention now will be described more fully with reference to the accompanying drawings, in which the preferred embodiments of the invention are shown. While the present invention is described as a single personal mobile display system corresponding a single corresponding host system on a typical local area environment, it should be appreciated by those skilled in the art the benefits and advantages of present invention is also applicable to a corporate-wide client/server environment. The present invention may, however, embodied in many different forms and should not be construed as limited to the embodiment set forth herein; rather these embodiments are provided so that this disclosure will be thorough and complete and will fully convey the invention to those skilled in the art.

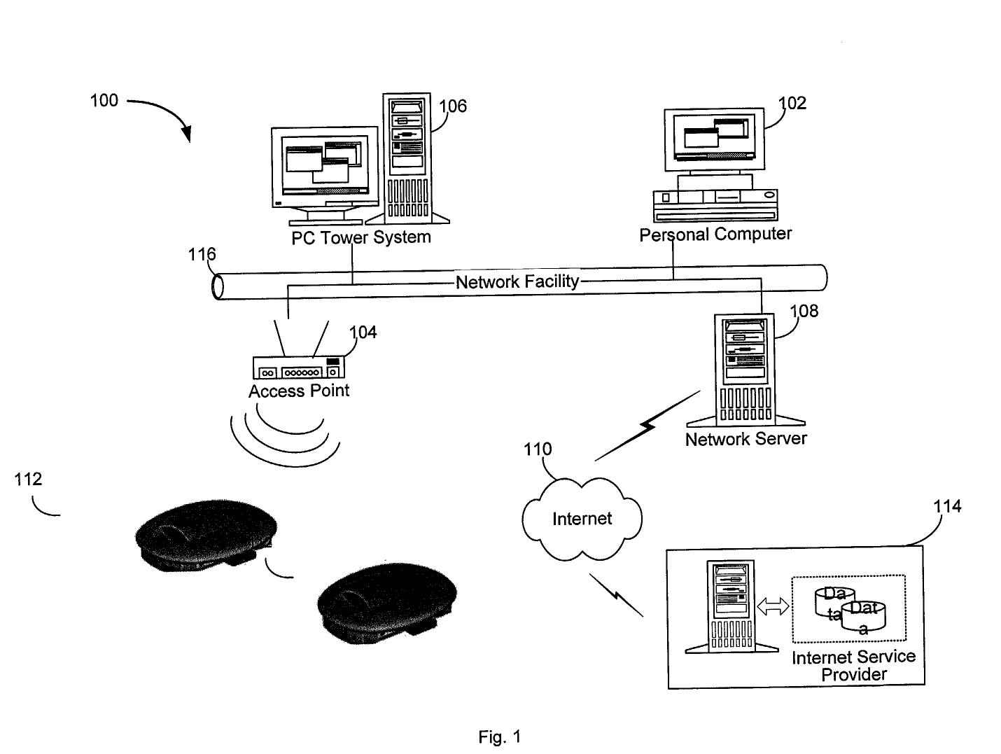

The invention will now be described with respect to FIG. 1, which illustrates the preferred embodiment of the invention shown in a corporate-wide client/server-networking environment 100. As shown in FIG. 1, the computer network 100 includes several workstations or systems 102, 106 connected via a network facility 116, such as an Ethernet-based local area network, to a server 108. The host systems represented by PC workstation 102 and PC-based tower system 106 shown in FIG. 1, are Intel Pentium™, Microsoft Windows™ based platforms. Each system runs a plurality of commercially available applications as well as, in accordance with the present application, an interactive cooperative application that establishes a wireless communication channel via the network and the access point transceiver 104, to one or more wireless interactive presentation system (WIPS) 112 that have been strategically placed throughout a corporate facility or campus. The interactive cooperative application is not restricted to Intel Pentium™ or Microsoft Windows™ based platforms but rather it is capable of being implemented on any platform, type of processor or operating system. In addition, the application programs executed by either the PC workstation 102 or PC-based tower system 106 are substantially without restriction in relationship to limitations imposed or potentially imposed by the present invention.

As FIG. 1 shows an access-point transceivers 104 connected to the network 116. Typically, several access-point transceivers 104 will be strategically placed throughout a corporate facility. Each transceiver 104 acts as a bridge between the workstations or systems, represented by PC workstation 102 and PC-based tower system 106, connected to the network and a corresponding wireless interactive presentation system (WIPS) 112. The access point transceivers 104 utilize the IEEE 802.11(b) Ethernet standard for wireless networks and a corresponding TCP/IP protocol to communicate with the wireless interactive presentation system (WIPS) 112 within a radius of several hundred feet and at speeds of between one to two megabits per second.

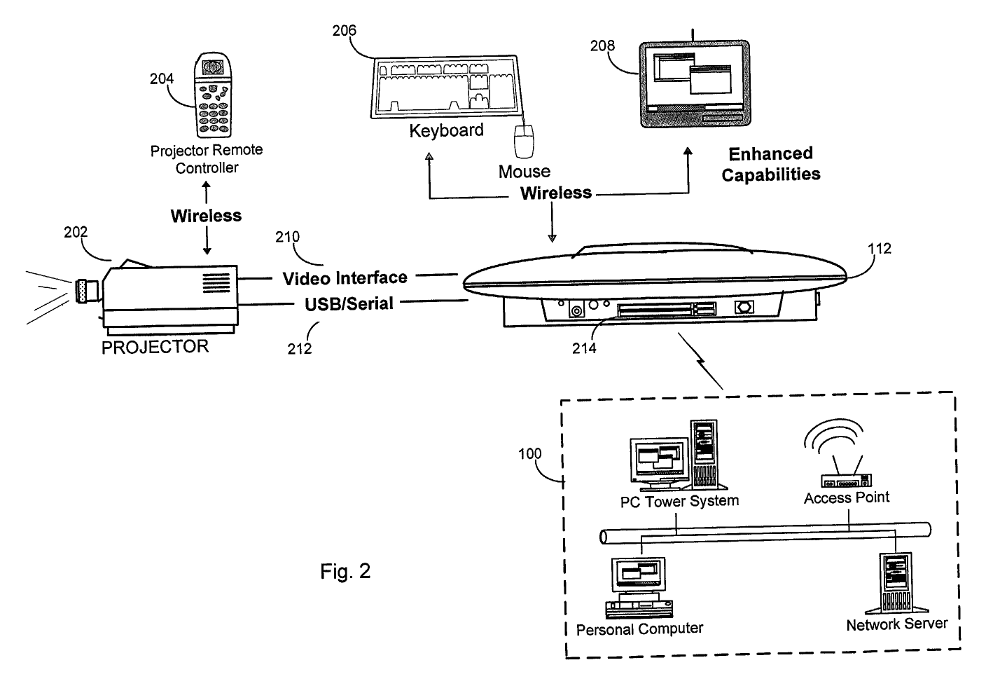

FIG. 2 is a block diagram of the detailing the major operative feature and functions of the wireless interactive presentation system (WIPS) in accordance with the present invention. As Fig.2 illustrates the wireless interactive presentation system 112 is interfaced to a projector 202 through either a video display interface 210 that can also be used to connect a industry standard display monitor or via a USB/Serial port 212. In addition, the wireless interactive presentation system 112 has the capability allowing the speaker to access a series of application he might require the presentation via a wireless keyboard and or a mouse 208. In addition, the capabilities of the wireless interactive presentation can be further enhanced by using a personal mobile display system 208, as well. As FIG. 2 also shows the wireless interactive presentation system 112 communicates via a wireless transceiver 214 through the an access point of network 100 to at least one corresponding system.

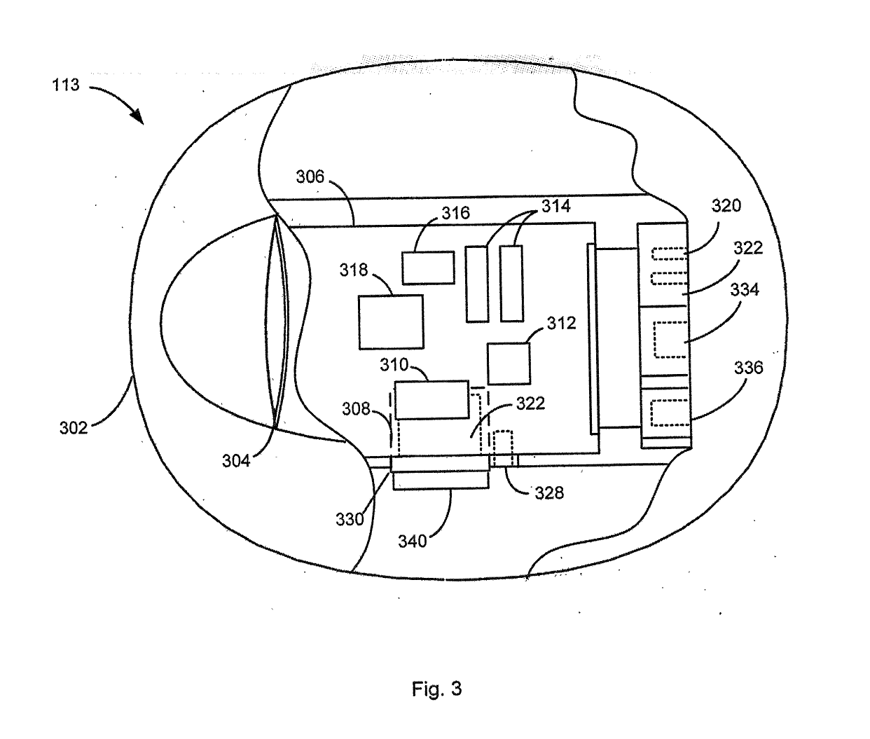

Reference is now made to FIG. 3 that is a diagram that illustrates a cut away view of the wireless interactive presentation system (WIPS) as implemented by the preferred embodiment of the present invention. The wireless interactive presentation system (WIPS) 112 is approximately eight by ten inches in size, weighing less than three pounds providing a user with the flexibility to present and more easily develop a rapport with his audience. As FIG. 3 shows an enclosure 302 that houses a infrared remote access receiver 304, a on-board processing system 306, a dual PCMCIA card subsystem 308 as well as an array of PC-oriented communications and I/O interfaces 320-328. The infrared remote access receiver 304 allows a speaker to interactively access presentation material and content on a remote system that resides on corporate network and or remotely control the projector used to make the presentation. The a infrared remote access receiver 204 provides the facility that allows the speaker to use an infrared keyboard and mouse to open files, enter information or navigate through application template or windows without leaving his position behind the lectern.

The on-board processing system 306 includes an embedded 32-bit RISC-based microprocessor 310, a peripheral controller and co-processor 312, main memory 314 and FLASH memory 316. The main memory 314 is of sufficient size to execute the primary functions of an operating system such as Window CE™ as well as those application programs that are supplied with the personal mobile display. Here, the FLASH memory 316 is configured as a “solid state” disk that used to support the mired of operating system functions. The peripheral controller and co-processor 312 is a companion processor to the embedded 32-bit RISC microprocessor 310 that provides operative control of the infrared receiver 304 and audio CODEC, the two PCMCIA slots 230, 332, as well as the host USB port 326, a device USB port 328, a pair of audio ports 320, 322, and a standard VGA port 324. The motherboard 306 also includes integrated video display subsystem 318. The integrated video display subsystem 318 manages the functions that support a Windows™—like desktop and applications environment as well as the operative functions of the projector (not shown). Thus, from a user's prospective, the wireless interactive presentation system 112 provides the look and feel of any Windows™ based presentation or graphics application system but is not constrained by the potential compatibility issues that might exist running on a corresponding remote system.

As shown in FIG. 3, the wireless interactive presentation system 112 is also configured with two PCMCIA slots 330, 332. The PCMCIA card slot 332 as shown in outline illustrates its preferred position in back of a portion of the wireless interactive presentation system 112. Each slot of the dual PCMCIA card subsystem 308 is able to receive a PCMCIA card. A PCMCIA card 340 inserted into at least one PCMCIA slot 330, 332 adds desired functionality to the wireless interactive presentation system 112. One of the PCMCIA cards installed in a PCMCIA slot 330, 332 is a wireless transceiver that allows the wireless interactive presentation system 112 to remotely communicate with a user's desktop system. Since the PCMCIA card 340 is shielded, there is very little, if any, electromagnetic interference between the electronics in the card and the components on the motherboard 306 infrared remote access receiver 304 mounted into the enclosure 302.

The flexibility and functionality of the wireless interactive presentation system 112 may be enhanced by the addition of a PCMCIA peripheral card 340. Since conventional PCMCIA cards are removable, the function or functions can be easily added to the wireless interactive presentation system 112. For example, a PCMCIA card having a cellular phone interface allows the wireless interactive presentation system 112 to be operated at an even greater distance from a host computer 102, 106 through a combination of air-links and land-lines that route to a host computer system 102, 106 in a conventional manner. A PCMCIA card may also be a modem or other high-speed serial or parallel interface that can connect either directly to a host computer 102, 106 when the wireless interactive presentation system 112 is conveniently close to the host computer 102, 106 or remotely through any combination of air-links and land-lines. PCMCIA cards may also be added to enhance the multimedia capabilities of the wireless interactive presentation system 112, add data communications capabilities including an Ethernet data connection or to upgrade the capabilities of the wireless interactive presentation system 112 in such areas as encryption or data compression.

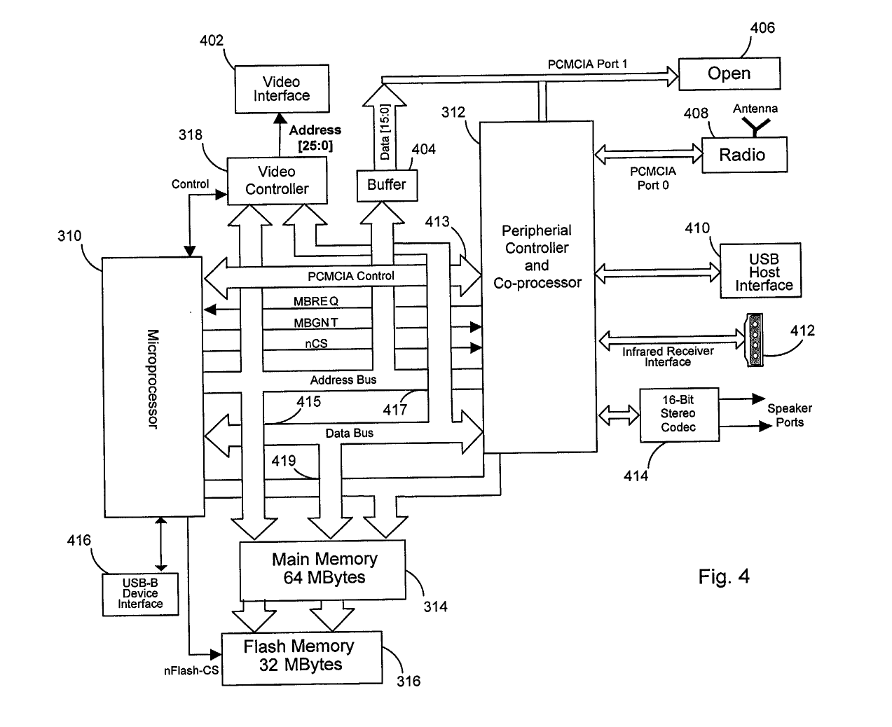

Reference is now made to FIG. 4 that is a block diagram detailing the operative components found on the on-board processing system as implemented by the present invention. As FIG. 4 shows the on-board processing system includes an embedded microprocessor 310, a peripheral controller and co-processor 312, sixty-four megabytes of SDRAM main memory 314 and thirty-two megabytes of FLASH memory 316. The embedded microprocessor 310 is a general purpose, 32-bit RISC processor running at approximately 206 MHz. The internal architecture of embedded 32-bit RISC microprocessor 310 includes a sixteen kilobytes instruction; eight kilobytes write-back data cache, memory-management unit (MMU), and a read and write buffer that are software compatible with the ARM V4 specification. The embedded microprocessor 310, in accordance with the present invention, accesses the sixty-four megabytes of main memory 314 and the thirty-two megabytes of FLASH memory 316 via a thirty-two bits wide high-speed data bus 415. In addition, the embedded microprocessor 310 provides system support logic for one or more serial communication ports, a number of I/O interfaces and the two PCMCIA ports 430, 432.

As FIG. 3 shows, the embedded microprocessor 310 is directly interfaced to the peripheral controller and co-processor 312 through a system bus interface 419. The peripheral controller and co-processor 312 is a highly integrated and low power companion processor to the embedded microprocessor 310 that provides controller support for a USB host interface 410, a infrared receiver interface 412 and a sixteen bit audio CODEC 414 that drives speaker ports for a set of speakers (not shown). In addition, the peripheral controller and co-processor 312 provides the interface to directly drive or control PCMCIA port 0 408 and PCMCIA slot 1 406. The peripheral controller and co-processor 312 also provide full detection and voltage control for both 3.3V and 5 V PCMCIA cards. In response to commands from the embedded microprocessorc 310, the peripheral controller and co-processor 312 directs all required functions of the wireless transceiver installed in PCMCIA Port 0 408 and any key I/O capabilities designed to be used by the wireless interactive presentation system 112 via a PCMCIA card that might be installed in the slot supported by PCMCIA port 1 406.

The integrated video display controller 318 is a single chip graphics engine with two on-board graphics controllers that share up to two megabytes of on-chip display memory. The integrated video display subsystem 318 extends look and feel of a Window™ like desktop display to either a projector or LCD presentation display facility. The integrated video display subsystem 318 retrieves image data from its on-board memory and transmits the image via the video interface 402 to either a projector or LCD presentation display facility. Typically, images stored in memory or those generated by a series of graphics operations such as area fill, block move, line draw, etc. are received and placed in the on-board memory by the integrated video display subsystem 318 and then are supplied to the on-board graphics controller for processing.

A conventional AC power source (not shown) provides the necessary power to wireless interactive presentation system 112 from either an external power or the onboard battery 346. In addition, independent power regulation is provided to the 16 bit CODEC 414, the dual PCMCIA slot 330, infrared receiver interface 412, and USB Host interface 410. Power may be regulated selectively for other components of the wireless interactive presentation system 112 where continued or excessive power consumption is unnecessary or undesirable.

While the foregoing detailed description has described several embodiments of the wireless interactive presentation system in accordance with this invention, it is to be understood that the above description is illustrative only and not limiting of the disclosed invention. A wireless interactive presentation system and a new thin-client oriented computer system paradigm have been described. While the present invention has been described particularly with reference to those professionals that require access to specific applications, presentation materials and content from his or her desktop system, the use of wireless interactive presentation system of the present invention is not limited to such an environment. Thus, business and industrial applications resources can be made readily available for concurrent, independent and collaborative access to present on a remotest system to one or more users. Furthermore, a wireless interactive presentation system is consistent with the present invention is not restricted to operating with a single host computer. Rather, through the implementation of conventional authentication schemes or procedures, selection of one or more wireless interactive presentation systems can simultaneously support a presentation or lecture to an audiences meeting in a number of conference rooms throughout a single corporate facility or throughout an entire corporate campus.

In view of the above description of the preferred embodiments of the present invention, those of skill in the art will readily appreciate many modifications and variations of the disclosed embodiments. It is therefore to be understood that, within the scope of the appended claims, the invention may be practiced otherwise than as specifically described above.

What is claimed is:

1. A wireless interactive presentation system that operates in cooperation with a remote system executing a plurality of application programs to facilitate projecting text, images and graphics, wherein the wireless interactive projection device comprises:
an integrated video and graphics subsystem that interfaces to a projection device and supplies the required text, images and text content to the presentation device;
a wireless transceiver configured to transmit and receive a data stream from at least one corresponding remote system wherein the data stream includes both graphics, command functions and application content generated by a network-based desktop computer system executing a plurality of application programs; and
an on-board processing system that processes the incoming data stream containing command functions, graphics and application content received from a corresponding remote computer system for display by the projection device, the on-board processing system also processes command function and user supplied input received from the infrared receiver and transmits the command functions and user supplied input, through the wireless transceiver, to the corresponding remote computer system.

2. The wireless interactive presentation system as recited in claim 1, wherein the on-board processing system executes an application program having unique operational command functions that processes and directs the integrated video and graphics subsystem to supply text, images and graphics content to the projection device through a standard video display interface that corresponds to the text, images and graphics content created and displayed on the network based computer system.

3. The wireless interactive presentation system as recited in claim 1, wherein the on-board processing system executes a series of unique operational command functions that processes and directs the integrated video and graphics subsystem to supply text, images and graphics content to the projection device through a USB/Serial interface that corresponds to the text, images and graphics content created and displayed on the remote computer system.

4. The wireless interactive presentation system as recited in claim 1, wherein the video and graphic subsystem supports a graphical user interface that presents the user with text, images and graphics content in a windows-like desktop format.

5. The wireless interactive presentation system as recited in claim 2, wherein the format of text, images and graphics content that is displayed on the projection device is determined by one or more application programs executed on the corresponding remote system.

6. A wireless interactive presentation system that operates in cooperation with a remote computer system executing an array of application programs, wherein the wireless interactive presentation system comprises:
an infrared receiver that provides the functionality for a plurality of wireless infrared-based devices to access and interact with both the wireless interactive presentation system and the plurality of application programs on the remote system;
a integrated video and graphic subsystem that provides command and control for a projection device;
on-board processing subsystem interfaced to the integrated video and graphics subsystem and the wireless transceiver that processes an incoming data stream received from a corresponding remote computer system for display by the projection device, the on-board processing system also processes user supplied input and transmits the user supplied input, through the wireless transceiver, to the corresponding network-based computer system.
a wireless transceiver configured to exchange data with a corresponding network-based computer system within a specified distance of the corresponding network-based computer system, the data including command functions, graphics and application content sent from corresponding remote computer system to the wireless interactive presentation system and user input data sent from the wireless interactive presentation system to corresponding network-based computer system; and
an enclosure having an top assembly and a bottom assembly that houses the on-board processing subsystem, the wireless transceiver, the integrated video and graphics subsystem and the infrared receiver.

7. The wireless interactive presentation system as recited in claim 5, wherein the wireless interactive presentation system further comprises a dual PCMCIA slot and a plurality of I/O interface ports wherein the I/O interface ports include a host USB port, a device USB port, a pair of audio ports, and a VGA port.

8. The wireless interactive presentation system as recited in claim 5, wherein the on-board processing subsystem that includes an embedded microprocessor, a companion peripheral controller and co-processor, main memory, non-volatile memory.

9. The wireless interactive presentation system as recited in claim 7, wherein the embedded microprocessor of the on-board processing subsystem is a general purpose, 32-bit RISC processor.

10. The wireless interactive presentation system as recited in claim 7, wherein the companion peripheral controller and co-processor of the on-board processing subsystem is a companion processor interfaced to the embedded microprocessor through a system bus interface.

11. The wireless interactive presentation system as recited in claim 9, wherein the companion peripheral controller and co-processor of the on-board processing subsystem directs the functionality of the dual PCMCIA slots where a wireless transceiver installed in a first PCMCIA slot while a second PCMCIA slot is available for other key I/O capabilities designed that may be required by the personal mobile display.

12. The wireless interactive presentation system as recited in claim 6, wherein the dual PCMCIA slot supports both 3.3V and 5 V PCMCIA cards.

13. The wireless interactive presentation system as recited in claim 7, wherein the embedded processor of the on-board processing subsystem is able to access sixty-four megabytes of main memory and thiry-two megabytes of non-volatile memory through a thirty-two bits wide high-speed bus.

14. The wireless interactive presentation system as recited in claim 12, wherein the main memory is SDRAM, thirty-two bits wide.

15. The wireless interactive presentation system as recited in claim 12, wherein the non-volatile memory is FLASH memory, sixteen bits wide.

16. The wireless interactive presentation system as recited in claim 5, wherein the integrated video and graphics subsystem includes a video controller supplies operative functionality to the projection device.

17. The wireless interactive presentation system as recited in claim 15, wherein the video controller provides the operative functionality allowing text, image and graphic content to have the look and feel of a Windows ™—like environment.

18. The wireless interactive presentation system as recited in claim 5, wherein the projection device is interface to the wireless interactive presentation system via a standard composite video interface port.

19. The wireless interactive presentation system as recited in claim 5, wherein the projection device is interface to the wireless interactive presentation system via a USB/Serial port.

20. The wireless interactive presentation system as recited in claim 5, wherein the infrared receiver communicates with and receives user specified input by means of a wireless infrared keyboard and or a wireless infrared mouse.

21. The wireless interactive presentation system as recited in claim 5, wherein the infrared receiver communicates with and receives user specified input by means of a wireless infrared keyboard and or a wireless infrared mouse.

22. The wireless interactive presentation system as recited in claim 17 wherein a external power supply interface disposed at the base of the enclosure in said case operably attached to a system power supply unit, where the system power supply unit includes a power supply port coupled to the base power supply, and said base support port is aligned to said power supply interface disposed at the base of the enclosure.
